(19) United States
(12) Patent Application Publication
(10) Pub. No.: US 2002/0129261 A1
(43) Pub. Date: Sep. 12, 2002

(54) Apparatus and method for encrypting and decrypting data recorded on portable cryptographic tokens

(76) Inventors: Daryl Carvis Cromer, Apex, NC (US); Howard Jeffrey Locker, Cary, NC (US); Andy Lloyd Trotter, Raleigh, NC (US); James Peter Ward, Raleigh, NC (US)

Correspondence Address: IBM Corporation, Personal and Printing Systems Group, Dept. 9CCA/Bldg. 002-2, P.O. Box 12195, Research Triangle Park, NC, 27709, US

(21) Appl. No.: 09/802,200

(22) Filed: Mar. 8, 2001

(51) Int. Cl. H04L 9/32

(52) U.S. Cl. 713/193

(57) ABSTRACT

A number of client systems receive a common secure transfer key pair from a server during initialization. The secure transfer private key is encrypted in the server with a platform public key sent to the server from the client system. Each client system is then able to encrypt data, using a secure transfer public key, to be recorded on a computer readable medium, and subsequently to decrypt such data using a secure transfer private key. Preferably, each client system includes an embedded security subsystem (ESS) performing cryptographic processes and providing secure key storage. Then, the secure transfer private key is stored as encrypted, and is decrypted using a private key within the ESS. Preferably, the platform private key is also stored encrypted, to be decrypted within the ESS using a hardware private key.

### BACKGROUND INFORMATION

1. Field of Invention

This invention relates to a method for generating tokens including recorded encrypted data and for subsequently decrypting such data at one of a number of computers, and, more particularly, to a method using a token including data encrypted and recorded at a local computer to enable a remote computer decrypting the data to perform a predetermined function.

2. Background Art

In general, an access token is a block of computer usable code, used within a computing system that includes information about the identity and privileges of an individual or account associated with particular processes, which can occur within the computing system. For example, a security program executing within a computing system may create an access token when a password supplied by a user is matched with information stored in a security database. Alternately, a portable token is carried to the computing system by the user, who causes data stored within the portable token to be read by the computing system in an attempt to gain access to the computing system.

A first form of portable token is conventionally a computer recordable and readable medium, such as a card with a magnetic stripe or a floppy disk. Such a portable token has no cryptographic capability of its own, but may store cryptographic keys or identifier information. This type of portable token has advantages of low cost and widespread availability in the form of a number of familiar formats. However, the level of security provided with the use of such a portable token is limited by the fact that all encryption and decryption must be done in the computing systems using the token with the cryptographic key of the data being exposed within the computing system during all conventional cryptographic operations. Such exposure can constitute a security risk because programs have been developed to obtain surreptitious control of a computing system in a manner allowing a remote user to gather information, reconfigure the system, and operate the system according to commands typed by the remote user. A routine for gaining control of a computer in this way is typically a part of a “Trojan horse” program, which is disguised as a game, utility, or other application to be downloaded or otherwise installed by an unknowing user. Alternately, such a routine may be part of a “back door” program surreptitiously installed by an intruder on a computer left unattended or left behind by a disgruntled employee to gain future access to the computing system.

A second form of portable token provides both protected storage for a PIN, cryptographic key data, and cryptographic execution capabilities. This type of portable token is conventionally provided in the form of a smart card, the size of a credit card, including a built in microprocessor and data storage capability. The microprocessor is programmed to perform cryptographic functions, using key material, which is stored within the smart card and not transferred from the smart card. A system for personalization of smart cards, which works with a variety of security methodologies, is described in U.S. Pat. No. 5,889,941, issued to Tushie et al. in 1999.

When compared to the first form of portable token described above, a cryptographic smart card enables substantially greater security, since the private key and cryptographic processes occurring within the smart card, not being exposed within the computing system being accessed, cannot be transmitted or used by a program surreptitiously operating within the computing system. However, the use of smart cards in this way has a significant disadvantage of increased cost due to a requirement to include specialized circuit modules for information storage and cryptographic processing. Also, a smart card must be read in a smart card reader, which is in turn plugged into a serial port, USB port, or PCMCIA slot of a computing system.

Thus, what is needed is a method for providing the additional security benefits of using a smart card as a portable token, together with the lower cost benefits and ease of wide usage of a simple computer readable medium as a portable token. Public key cryptography, which is now widely used for communications over the Internet involving the transmission of secure financial data, PIN numbers, or passwords, is made possible by the development of asymmetric cryptography, in which the key used to encrypt a message is different from the key used to decrypt the message. Before the development of asymmetric cryptography, cryptographic methods were symmetric, with a process carried out with a key to encrypt a message being reversed with the same key to decrypt the encrypted message. The tremendous advantage of public key cryptography arises from the fact that there is no need to develop a method for securely distributing symmetric or private keys to all of the people who may need them.

With public key cryptography, each entity involved in a secure transaction has a key pair, including a private key and a public key. The public key is made widely available, while the owner holds the private key as a secret, typically within the computing system or a secure token. When a sender wants to send an encrypted message to a receiver, he encrypts it with the public key of the receiver. When the receiver receives the message, he decrypts it with his private key. Since no one else knows his private key, no one else can decrypt the message, even if they intercept the public key and the message during transmission. The private key cannot reasonably be deduced or calculated from the public key. This type of cryptography was proposed by Bradley W. Diffie and Martin E. Hellman, and is described in U.S. Pat. No. 4,200,770, issued to Hellman et al. in 1980, the disclosure of which is incorporated herein by reference. Another asymmetric key algorithm, named the RSA algorithm after the inventors Ronald L. Rivest, Adi Shamir, and Leonard M. Adleman, is described in U.S. Pat. No. 4,405,829, issued to Rivest et al. in 1983, the disclosure of which is incorporated herein by reference.

Within a computing system, cryptographic processes manipulate the binary numbers representing an alphanumeric message according to a key. The manipulation includes, for example, substitution and transposition, in which elements of the message are substituted for other elements, or their positions are switched, or both. The manipulations conventionally occur within general purpose computer hardware in accordance with a cryptographic routine executing within the processor of a computing system.

What is needed is a method for applying principles of public key cryptography to the encryption and decryption of data stored in portable tokens without exposing private keys and cryptographic processes within computing systems.

Digital signatures are often used in the communication of messages over a network, using the RSA algorithm, to authenticate the identity of the person sending a message. An example of a format for a digital signature system is described in the IBM Technical Disclosure Bulletin, Vol. 39, No. 12, December, 1996. While digital signatures are effective in providing assurances that messages are not forged, have not been altered, and were sent at the time defined in the message, the owner still needs a mechanism to securely transport their private signing key. For a user traveling from one system to another, this is most easily accomplished through the use of a portable token. For example, when a user of a banking system approaches an ATM, he wants the local system to perform a function for him. Alternately, a person traveling among various locations of an organization may want to send messages or perform other operations on the computing systems at these various locations. Therefore, what is needed is a method for improving the level of security achievable through the use of portable tokens, which can be easily carried by the user, while retaining low implementation costs and ease of use.

Within an individual computing system, a security subsystem having a capability to perform encryption and decryption may be installed to avoid exposing cryptographic processes, and particularly a private key, within the computing system. With such a subsystem, the cryptographic process is performed within specialized hardware, instead of in conventional hardware of a computer under control of a cryptographic program. An example of such a subsystem is found in the IBM security chip, which includes a microprocessor and associated secure memory soldered onto the system board of a computing system and connected to the main processor of the system through a local bus. A Trojan horse program surreptitiously operating in the computing system cannot detect the private key being used only within the protected environment of the security subsystem,

An example of the use of security subsystems is found in U.S. Pat. No. 5,787,172, issued to Arnold in 1998, which describes a secure cryptographic network, established among operational units in a system, in which every operational unit comprises a secure chip integrated circuit. These secure chips include a programmable processor and a read-only memory. A public key cryptosystem is initially used to establish secure communication links. Then, each secure communication link is provided with a unique private encryption key from a private key cryptosystem. The operational units include a master key station (MKS), a personalization station (PS), and a registration station (RS). The MKS functions as a trusted authority and directly or indirectly authenticates every secure chip in the system. First, the MKS generates an MKS signature pair having a public key, which has been programmed into the read-only memory of each of secure chip, so that each unit has access to this public key. Then, during a process of personalization, the MKS or a PS provides each secure chip with a public and private rekey key pair.

During a subsequent process of registration, the unit being registered provides a public rekey key and a chain of authentication certificates to the registering unit, which authenticates the unit being registered by verifying the source and content of these certificates. The registering unit then generates a private encryption key, or a package of several keys, that will be unique to the system being registered. The registering unit encrypts the private encryption key with the public rekey key of the unit being registered and transmits this private encryption key to the unit being registered, along with a chain of authentication certificates. When a secure communications link is established between two operational units, each of the operational units authenticates the other operational unit by verifying the content and source of each of the authentication certificates in the respective chains of authorization certificates of the two operational units.

While U.S. Pat. No. 5,787,172 describes a communications network including a number of related systems having security subsystems, what is needed is a way to generate portable tokens that may be carried by a user among the various systems. Also, what is needed is a method for enabling associated systems having security subsystems to communicate, using encrypted information, with one another without a need to transmit a private key to be used within each security subsystem. An enhanced level of security is achievable when the private key used in each security subsystem is not transmitted outside the system. Also, what is needed is a method for enabling such communication among associated systems with a single initiation process, instead of separate processes of personalization and registration. Furthermore, what is needed is a method for allowing such communication without a need to verify the contents of two chains of authorization certificates.

### SUMMARY OF THE INVENTION

A first objective of this invention is to provide for encrypting data to be recorded on a portable computer readable medium at a computer and for subsequently decrypting the data at the same computer or at another computer enabled to provide such decryption.

Another objective of this invention is to provide for encryption and decryption of data recorded on a portable computer readable medium with critical cryptographic processes being carried out within a cryptographic subsystem embedded within a computer to provide security against surreptitious operation of a Trojan horse program within the computer.

A further objective of this invention is to provide for enabling performance of a predetermined task, such as providing access to confidential information, or providing an ability to manipulate data associated with a particular account, in a remote computer system after a user causes a portable computer readable medium storing encrypted data to be read by the remote computer system, with the encrypted data being decrypted

Yet another objective of this invention is to establish a group or domain of associated computer systems, each of which can be accessed by a user with a cryptographic token, without requiring other communications among the computer systems.

In accordance with a first aspect of the present invention, a system is provided for encrypting a portion of token data, for recording the token data with a portion of the token data in an encrypted form on a computer readable medium, for reading the token data and decrypting the portion of the token data. The system includes a number of client computers, a server, and a communications network connecting the server with each of the client computers. The server generates a secure transfer key pair and encrypts a private key of said secure transfer key pair. The secure transfer key pair is transferred to each of the client computers with the private key of the secure transfer key pair in an encrypted form. (As described herein, a “key pair” is understood to have the conventional meaning of a private key, which is held in secret, and a public key, which is made freely available. After a message is encrypted using the public key, it can be decrypted using the private key. While the private key and the public key of a key pair are related in this way, the private key cannot be reasonably calculated or deduced from the public key. A key pair is generated and used for encryption and decryption with conventional cryptographic techniques.) Each client computer is programmed to generate token data including the portion of the token data encrypted with a public key of the secure transfer key pair, to record the token data on a computer readable medium, to read the token data from the computer readable medium, to decrypt the private key of the secure transfer key pair and to decrypt the portion of the token data with the private key of the secure transfer key pair. Each client computer may be enabled to perform a predetermined task in response to decrypting the portion of the token data.

Preferably, the secure transmission of the private key of the secure transfer key is facilitated by the generation, within the client computer, of a platform key pair, with the public key of the platform key pair being transmitted to the server over the communications network and with the private key of the secure transfer key pair being transmitted to the client computer encrypted with the public key of the platform key pair.

Preferably, security of the cryptographic process is enhanced through the use of a security subsystem including a separate processor and storage, with each client computer generating a hardware key pair within the security subsystem and storing the private key of the hardware key pair in the storage of the security subsystem. A private key of the platform key pair is then encrypted with the hardware public key and is decrypted with the hardware private key in the security subsystem before the private key of the platform key pair is used to decrypt within the security subsystem the private key of the secure transfer key pair.

Preferably, each client computer in the plurality of client computers also includes an input device for providing a numeric input, and the portion of the token data being encrypted and subsequently decrypted includes a PIN, (Personal Identification Number) to be remembered by the user and provided as an input through the input device when using the computer readable medium. Then, each client computer, after decrypting the portion of the token data read from the computer readable medium, compares the PIN included within the token data with the numeric input provided through the input device, and is enabled to perform a predetermined task in response to determining an equivalence between the PIN and the numeric input provided through the input device.

Preferably, the client computers are each connected to the server over a communications network, with the public key of the platform key pair of each of the client computers being transmitted to the server over the communications network, and with the secure transfer key pair being transmitted to the client computer over the communications network with the private key of the secure transfer key pair encrypted with the public key of the platform key pair.

Alternately, computer readable media may be used to transfer the public key pair of a public key of the platform key pair from each of the client computers to the server and to transfer the secure transfer key pair from the server to each of the client computers, with the private key of the secure transfer key pair being encrypted with the public key of the platform key pair of that particular client computer.

In accordance with another aspect of the present invention, a method is provided for enabling performance of a predetermined task in a remote computer system through use of an encrypted portion of token data recorded in a local computer. The method includes:

establishing communication between the local computer and a server;

transferring a secure transfer key pair from the server to the local computer;

storing the secure transfer key pair within the local computer;establishing communication between the remote computer and the server;

transferring the secure transfer key pair from the server to the remote computer;

storing the secure transfer key pair within the remote computer;

encrypting the portion of the token data within the local computer with a public key of the secure transfer key pair;

recording the token data, including the portion of the token data encrypted with the public key of the secure transfer key pair, within the local computer on a computer readable medium;

transporting the computer readable medium from the local computer to the remote computer;

reading the token data, including the portion of the token data encrypted with the public key of the secure transfer key pair, within the remote computer from a computer readable medium;

decrypting the portion of the token data within the remote computer with a private key of the secure transfer key pair; and

enabling the performance of the predetermined task in the remote computer in response to the portion of the token data.

In accordance with another aspect of the present invention, a method is provided for establishing a plurality of associated client computers, wherein a client computer in said plurality of associated client computers performs a predetermined task in response to reading and decrypting token data recorded on a computer readable medium. The method includes:

generating a secure transfer key pair within a server;

transferring the secure transfer key pair from the server to each client computer in the plurality of associated client computers; and

storing the secure transfer key pair within each client computer in the plurality of associated client computers.

### BRIEF DESCRIPTION OF THE FIGURES

FIG. 1 is a block diagram of a number of associated client systems in communication with a server providing cryptographic services in accordance with the present invention;

FIG. 2 is a pictographic view of the a portable security token recorded on a computer readable medium by one of the associated client systems in FIG. 1 for use in other client systems in accordance with the present invention;

FIG. 3 is a flow chart of a process used to initialize one of the client systems in FIG. 1 through communications with the server in FIG. 1 to encrypt and decrypt data in accordance with the present invention;

FIG. 4 is a flow chart of a process occurring within one of the associated client systems in FIG. 1 to generate data recorded on the security token of FIG. 2, in accordance with the present invention;

FIG. 5 is a flow chart of a process occurring within one of the associated client systems in FIG. 1 in response to a request to read data recorded on the security token of FIG. 2, in accordance with the present invention;.

FIG. 6 is a flow chart of a process used to initialize one of the client systems in FIG. 1 through communications with the server in FIG. 1 to encrypt and decrypt data in accordance with a first alternative version of the present invention;

FIG. 7 is a flow chart of a process occurring within one of the associated client systems in FIG. 1 in response to a request to read data recorded on the security token of FIG. 2, in accordance with the first alternative version the present invention; and

FIG. 8 is a block diagram of a number of associated client systems in communication with a server providing cryptographic services in accordance with a second alternate version of the present invention.

FIG. 9 is a flow chart of different processes used to initialize one of the client systems in FIG. 8 to encrypt and decrypt data in accordance with the second alternative version of the present invention.

### DETAILED DESCRIPTION OF THE INVENTION

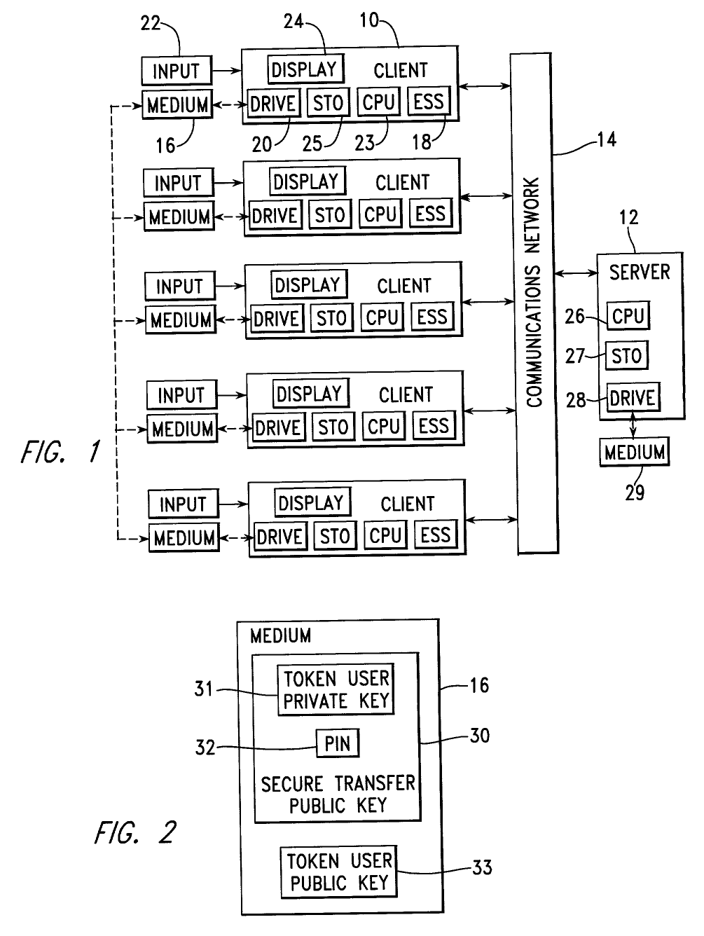

Referring to FIG. 1, a number of client systems 10 are associated by a need to identify a particular group of users and to provide services for these users once they have been properly identified. For example, the client systems 10 may be banking terminals providing a user within the group of users access to his individual account from a number of different locations. The client systems 10 may alternately, for example, form portions of a communications network forwarding messages only after the system user sending a message has been properly identified.

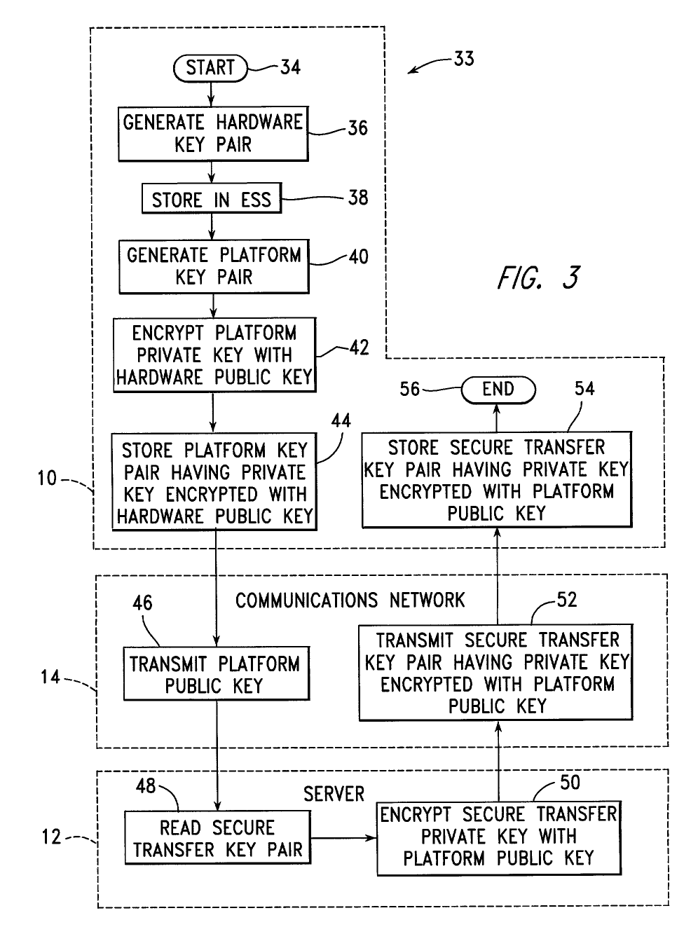

In accordance with the present invention, each of the client systems 10 is connected to a server 12 through a communications network 14, which may include, for example, the public switched telephone network, or leased telephone lines, and which may include the Internet. The client systems 10 do not need to be directly connectable to one another, but they each need to be connectable to the server 12, at least for an initialization process to be explained in reference to FIG. 3. Following initialization, each of the client systems 10 is configured to generate encrypted data and to record encrypted data on a token in the form of a computer readable medium 16, which can be physically carried to any of the other client systems 10, and which can then be decrypted to provide information describing the identity of the person having the medium 16.

Each of the client systems 10 preferably includes an embedded security system 18, which provides cryptographic capabilities within the system 10, while controlling access both to cryptographic functions and to securely stored data. Each client system 10 preferably also includes a drive 20 capable of writing data to the medium 16 and of reading data from the medium 16. Each client system 10 preferably further includes an input device 22, such as a keypad or a keyboard, which can be used to input a personal identification number (PIN). Each client system 10 further includes various conventional components allowing its use as a computing system or terminal, such as a processor 23, a display 24, and storage 25. Storage 25 may include both volatile and non-volatile components and sections for storing data and program instructions. Overall operation of the client system 10 occurs under control of a program or routine executing within the processor 23 of the system, with the processor 23 being connected to a security subsystem processor within the embedded security subsystem 18 by means of a local bus (not shown). Certain cryptographic operations are carried out only within the embedded security subsystem 18, with at least a private key being stored and used in a manner not providing access to the private key outside the embedded security subsystem 18.

The private key of the hardware key pair is preferably created within the embedded security subsystem. In this way, an advantage of an additional level of security is achieved over conventional systems in which all encryption and decryption processes occur within conventional circuits under control of cryptographic program, with such processes and private keys being exposed to possible intervention or misappropriation by a Trojan horse program operating within the system.

The instructions for a program or routine to execute within the processor 23 may be loaded to the client system 10 through the drive 20 from a computer readable medium, or the instructions for such a program may be transmitted to the client system 10 over the communications network 14. In either case, the instructions for such a program may be stored in storage 25.

The server 12 similarly may be a conventional computing device including a processor 26, storage 27, and a drive 27 for reading a computer readable medium 28. The operation of the server 12 is controlled by a program executing within its processor 26, with such a program having typically been loaded into the server 12 by means of the computer readable medium 29 or by receiving signals transmitted over the communications network 14.

The terms “client” and “server” are used herein to describe the relationship between the individual client systems 10 and the server 12 during a process performed in accordance with the present invention to initialize or prepare the client system 10 to make tokens. The terms “client” and “server” are thus not used to indicate that the server 12 is a large system of the type conventionally called a “server” or that the client system 10 is a smaller system than the server 12.

Referring to FIG. 2, the medium 16 is computer recordable and readable, being, for example, a floppy disk, a CD-R (Compact Disk-Recordable), a CD-RW (Compact Disk-Recordable, Writable), or flash memory device. Before data is recorded on the medium 16 for use as a cryptographic token, a first portion of the recorded data is preferably encrypted using a secure transfer public key 30, while a second portion of the recorded data is “clear,” unencrypted data. In the example of FIG. 2, the encrypted information includes a token user private key 31, which is associated with the particular person to which the medium 16 is assigned, or with a particular function to be enabled through use of the medium 16, together with a PIN 32, which is used to verify that the person attempting to gain access to a client system 10 by using the medium 16 is indeed the person to whom the token was issued. Also in the example of FIG. 2, the unencrypted information includes a token user public key 33, which is associated with the token user private key 26 in the conventional manner. That is, a message encrypted with the public key can be decrypted with the private key. The asymmetric key relationship is not limited to public key encrypting, private key decrypting. The reverse is also true; the private key can be used to encrypt and only the public key can then decrypt.

A key pair is understood to mean a private key and a public key, which may be generated by conventional cryptographic techniques, including the well-known RSA algorithm and techniques generally described in U.S. Pat. No. 4,405,829. The private key is held as a secret, as the public key is disseminated, and, despite the fact that the public and private keys of each type are related by their ability to encrypt and subsequently to decrypt a message, there is no reasonable way to deduce or calculate the private key from the public key.

Referring to FIGS. 1 and 2, the associated client systems 10 share a common secure transfer key pair, which they have received from the server 12 in a process to be described in reference to FIG. 3. This common secure transfer key pair allows the associated client systems 10 to share data securely in a form recorded on the computer readable medium 16. Such data is encrypted using the public key of the secure transfer key pair, and, after the medium 16 is taken to another client system 10, it is decrypted using the private key of the secure transfer key pair.

In one application of the present invention, a user of the client systems 10 has a token user key pair recorded upon the medium 16 at a local client system 10, with the private key of the token user key pair being encrypted in the public key of the secure transfer key pair. Then, after traveling to a remote location, the user presents the medium 18 as a portable token to be read by a remote client system 10, which decrypts the private key of the token user key pair using the private key of the secure transfer key pair. The token user key pair is then used to enable the remote client system 10 to perform certain predetermined functions, such as providing the user with access to account information, giving the user an ability of transfer funds within specific accounts, or digitally signing a correspondence. The user may also use the medium 18 to obtain repeated access to the local client system 10 on which it was recorded, for similar purposes.

The use of the computer readable medium 18 in this way provides a number of advantages over the prior art method of using a smart card. The computer readable medium can be a widely used medium, such as a 3.5-inch diameter floppy disk, which can be read at most computing systems without the addition of dedicated hardware, such as a smart card reader. The computer readable medium is typically considerably less expensive than an alternative smart card. The computer readable medium may provide a large capacity for recorded data. For example, the user may have many different token user keys, encrypted using the public keys of several different secure transfer key pairs, recorded on a single medium 18. The user could then use the medium 18 to gain access to a client system 10 in one of a number of groups of associated client systems 10, with each of the groups of associated client systems 10 using its own secure transfer key pair. Furthermore, the secure transfer key pair enables the creation of distinct usage domains with each domain having its own secure transfer key pair. Continuing to refer to FIGS. 1 and 2, and referring additionally to FIG. 3, a process, generally indicated as 33, for initializing a particular client system 10 to generate cryptographic tokens on media 16 for use in other associated client systems 10 and to decrypt cryptographic tokens generated within the other associated client systems 10, is started in step 34. This initialization process 33 includes a subroutine executing within the client system 10 and a subroutine executing within the server 12. Next, in step 36, a hardware key pair, which is unique to the client system 10, is generated, preferably within the ESS. This hardware key pair is preferably stored in the ESS 18, in step 38, with at least the private key of the hardware key pair remaining only in the ESS 18 for subsequent use in decrypting data within the ESS, thereby ensuring an additional capability to provide for security of this private key even if surreptitious control of the client system 10 is established, for example, through the use of a Trojan horse program.

Next, in step 40, a platform key pair, which is also unique to the client system 10, is generated. In step 40, the platform private key is encrypted with the hardware public key. Then, in step 42, the platform private key is encrypted with the hardware public key. The platform key pair, having the platform private key encrypted with the hardware public key, is stored within the client system 10 in step 46, and the platform public key is transmitted over the communications network 14 to the server 12. The platform private key encrypted with the hardware public key is safely stored within the client system 10, since it cannot be surreptitiously decrypted; it can only be decrypted with the hardware private key within the ESS 18 of this particular client system 10. The platform public key is safely transmitted over the communications network 14 since, being a public key from which the platform private key cannot be reasonably determined, it can be shared openly.

The server 12 is characterized by providing cryptographic services for the various client systems 10 through the use of a secure transfer key pair stored within the server 12. After the server 12 receives the platform public key transmitted over the communications network in step 46, the server 12 reads the secure transfer key pair from its memory in step 48. Then, in step 50, the server 12 encrypts the secure transfer private key with the intended target system platform public key. Next, in step 52, the server 12 transmits, to the client system 10 over the communications network 14, the secure transfer key pair with the secure transfer private key encrypted with the platform public key previously transmitted in step 46. Once again this is a secure operation since only the entity that controls the platform private key interpret the data.

Each platform public key transferred to the server 12 is unique for the particular client system 10 from which it is sent. When the secure transfer private key has been encrypted with the platform public key of the of a particular client system 10, it can only be decrypted by this client system 10. On the other hand, the particular secure transfer key pair is transmitted to each of the client systems 10, encrypted as described, each time a platform public key is received from one of the client systems 10. In this way, a relationship is established among the client systems 10, in that each system 10 receives from the server 12 the same secure transfer key pair, with the private key of the secure transfer key pair being encrypted with the platform public key of the particular client system 10.

At this point, in step 54, the secure transfer key pair is stored within the client system 10, with the private key encrypted with the platform public key of the client system 10. In this form, this data can be securely stored, since it can be decrypted only in the ESS 18 of the particular client system 10. At this point, the client system 10 has been prepared both to generate cryptographic tokens on media 16 for use with the other associated client systems 10, and for decrypting a token on a medium 16 generated by one of the other associated client systems 10, so the initialization process is ended in step 56.

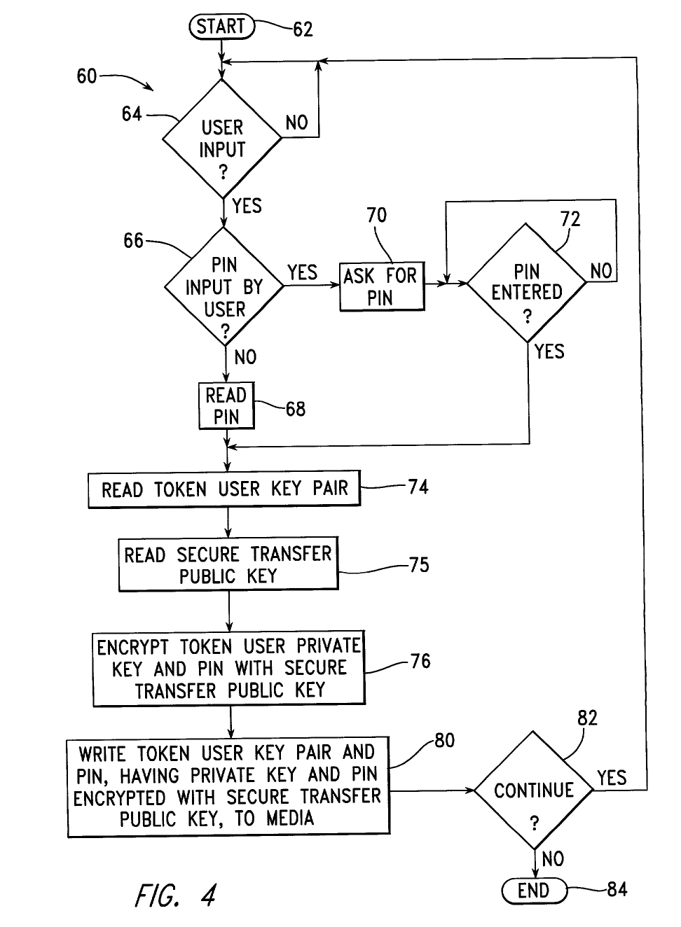

The operation of a subroutine, generally indicated as 60, within a particular client system 10 for generating a cryptographic token on a medium 16 will now be discussed, with particular reference being made to FIG. 4. After this token generating subroutine 60 is started in step 62, the subroutine waits in step 64 for an input by a user indicating that a cryptographic token is to be generated. Such an indication is made in a predetermined manner, for example, launched through an application, by making a menu selection with a cursor, by typing a command on the input device 22 of the client system 10, or by inserting a blank medium 16 into the drive 20 of the client system 10.

In the example of FIG. 4, the subroutine 60 provides for encrypting a PIN which is either provided by the user for whom a cryptographic token is being generated, or by the client system 10, being read, for example, from a table stored within the client system 10. Thus, when a determination is made in step 64 that a user has indicated that a cryptographic token is to be generated, the system proceeds to step 66, in which a determination is made of whether a PIN is to be provided by the user or by the system. If it is to be provided by the system, the PIN is read, for example from a table within the client system 10, in step 68. If it is to be provided by the user, the system asks, in step 70, for the user to provide the PIN. This is done by writing the request for a PIN on the display 24. When the PIN has been entered by the user, as determined in step 72, or when the PIN has been read from a table in step 68, the system proceeds to read a token user key pair, for example from a table, in step 74. Then, in step 75, the public key of the secure transfer key pair, which has been stored within the client system 10 during step 54 of the initialization process of FIG. 3, is read from storage 25. Next, in step 76, the private key of the token user key pair, together with the PIN, is encrypted with the secure transfer public key. Then, in step 80, this encrypted data, together with the unencrypted public key of the token user key pair, is written to the media 16, preparing the media 16 for subsequent use with any of the associated client systems 10.

In general, the client system 10 may be used for a number of different purposes. Thus, in step 82, a determination is made of whether the subroutine 60 is to be continued, to allow the subsequent generation of another cryptographic token. If the subroutine 60 is to be continued, the system returns to step 64 to wait for another user input requesting generation of a cryptographic token. Otherwise, the subroutine 60 is ended in step 84.

The operation of a process, generally indicated as 90, within a particular client system 10 for decrypting data stored on a medium 16 so that the medium can be used to enable or initiate operations within the client system 10. After this token decrypting subroutine 90 is started in step 92, the system waits in step 94 for a user input indicating that a cryptographic token is to be decrypted. Such an indication may be given, for example, by an application, by making a menu selection on the screen of display 24, by typing a command on the input device 22, or by inserting a medium 16, having the cryptographic token stored thereon, into the drive 20. When it is determined in step 94 that such an input has occurred, the system proceeds to step 96, in which the data stored on the medium 16 is read. This data, which has been previously recorded, generally in another client system 10 in step 80 of the subroutine 60 in FIG. 4, includes the token user key pair and the PIN, with the token user key pair private key and PIN having been encrypted with the secure transfer public key.

Next, in step 98, the platform private key encrypted with the hardware public key is loaded into the ESS 18 of the client system 10. This data has been stored in this form in step 44 of the initialization subroutine described above in reference to FIG. 3. Then, in step 100, the platform private key is decrypted with the hardware private key in the ESS 18. The hardware private key is only available within the ESS 18. Then, in step 102, the secure transfer private key, encrypted with the platform public key is loaded into the ESS 18. This data has been stored in this form in step 44 of the initialization subroutine described above in reference to FIG. 3. In step 104, the secure transfer private key is also decrypted in the ESS 18 using the platform private key. Then, in step 106, the token user private key and pin encrypted with the secure transfer public key, which have been read in this form from the medium 16 in step 96, are decrypted in the ESS 18, using the secure transfer private key, which has been decrypted in step 104.

In this way, the encrypted data recorded on the medium 16 has been completely decrypted. Next, in step 108, the user is asked to provide his PIN. This is done, for example, using text displayed on the display 24. In step 110, a determination is made of whether the PIN supplied by the user in response to step 108 matches the PIN stored on the medium 16, which has been decrypted in step 106. If these two PINs match, the system is enabled in step 112 to perform operations requiring the use of the cryptographic token recorded on the medium 16. As described above, in accordance with a preferred version of the present invention, the initiation of such operations requires both the decryption of encrypted information recorded on the medium and the proper input of a PIN by the user. Such operations occur in response to the particular data recorded on the medium, which only becomes available after decryption.

If the user does not properly reproduce the correct PIN, he is preferably allowed a maximum number of tries to reproduce it. If the PINs do not match, but if this maximum number has not been exceeded, as determined in step 114, the system returns to step 108, so that the user is asked again to supply the PIN.

When the maximum number of tries has been reached, the system proceeds to step 116, in which an indication of rejection is given, using the display device 24 of the client system 10.

The operations enabled by the use of the cryptographic token and thus performed in step 112 may include recording information on the computer usable medium 16 for secure delivery to another client system 10. If such information is to be recorded, the system returns to step 76, in which the data to be recorded in encrypted form is treated as a token user private key, being encrypted with the secure transfer public key and then written to the medium in encrypted form in step 80. In this way, it is understood that the present invention allows each of the associated client systems 10 to encrypt and write data to be read by one of the other associated client systems 10, through use of the secure transfer key pair.

Following step 112 or step 116, a determination is made in step 118 regarding whether the system should continue waiting for another attempt to respond to a user input. If a decision is made to continue, the system return to step 94; otherwise, this routine ends in step 120.

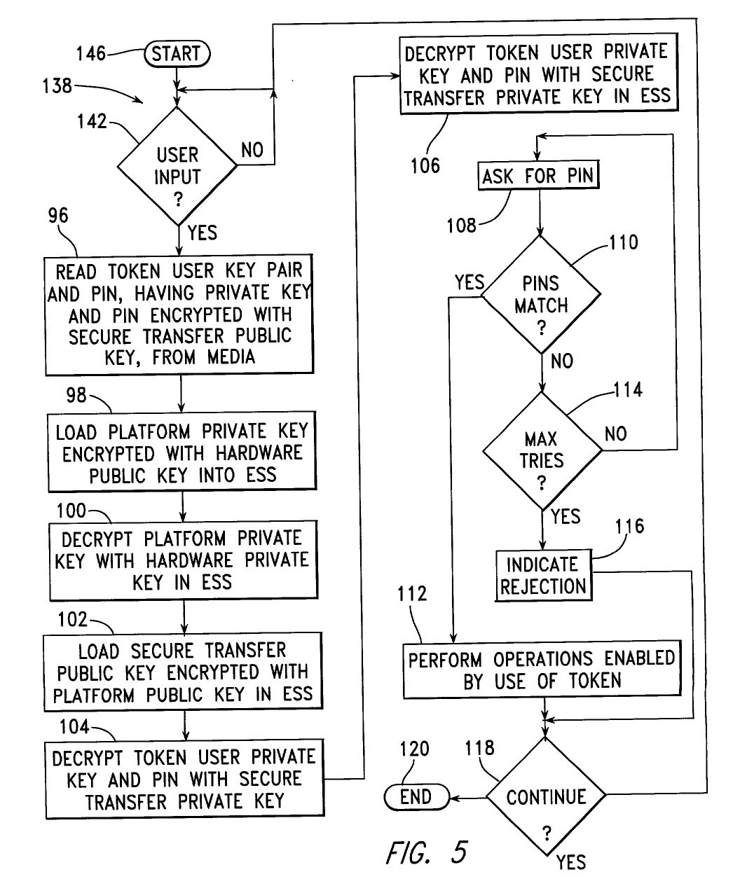

While the preceding discussion has described operation of a system in accordance with a preferred version of the present invention, it is understood that a number of variations may be made without departing from the spirit and scope of the invention. For example, while the above discussion describes, in reference to FIG. 4, a first subroutine 60 in which the system waits for a user to request data to be written on the computer readable medium 16, and, in reference to FIG. 5, a second subroutine 90 in which the system waits for a user to request data to be read from the computer readable medium 16, it is understood that, alternately, the system could wait in a single subroutine for a user to indicate either that he requests data to be written on a new medium 16 or that he requests data to be read from an existing medium 16. It is further understood that certain of the client systems 10 may be programmed only to write data on new media 16 by executing the first subroutine 60, while others of the client systems 10 are programmed only to read data on existing media 16 by executing the second subroutine 90.

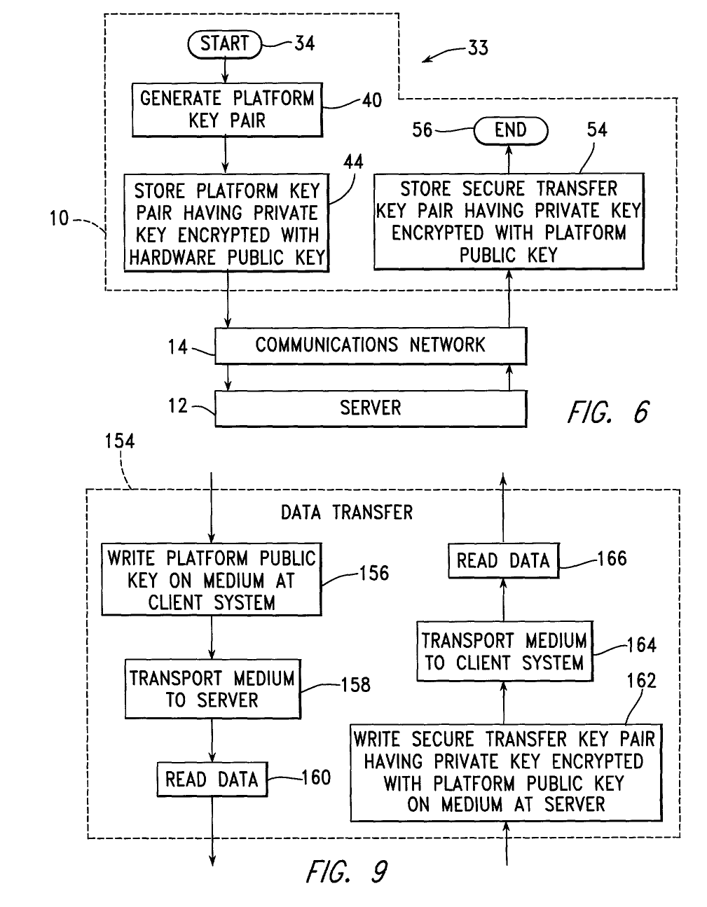

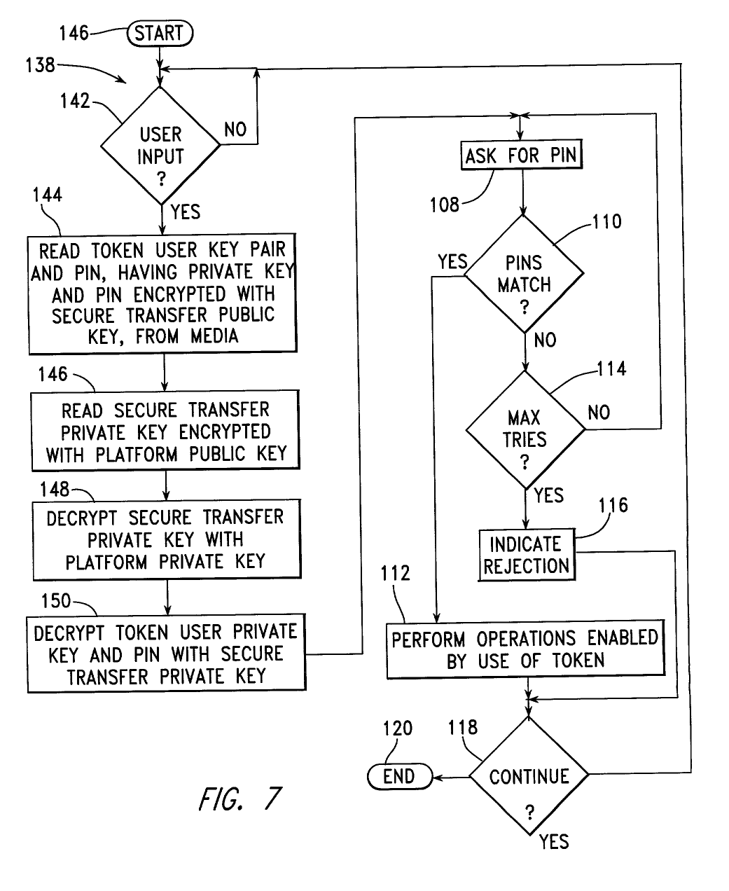

While the preceding discussion has described the operation of client systems 10 including embedded security subsystems 18, it is understood that an alternative version of the present invention does not require the use of embedded security subsystems 18. Such an alternative version of the present invention may be implemented in one or more client systems 10 not including an embedded subsystem 10, which is otherwise as described above in reference to FIG. 1. In this alternative version, the secure transfer key pair and the platform key pair are used essentially as described above, but the hardware key pair is not used. Operation of a client system 10 in accordance with this alternative version of the present invention will now be discussed, with particular reference being made to FIGS. 6 and 7.

Referring first to FIG. 6, when a client system 10 is to initialized to encrypt and decrypt information in accordance with this alternative version of the present invention, using a subroutine 124 starting in step 126, the system proceeds to step 128, in which a platform key pair is generated. In step 130, this platform key pair is stored within the storage 25 of the client subsystem. Since there is no hardware key pair, the private key of the platform key pair cannot be encrypted as previously described in reference to FIG. 3 before storage. However, subsequent operations within the communications network 14 and the server 12, i.e. processes occurring in steps 46, 48, 50, and 52, occur as described above in reference to FIG. 3. In fact, the communications network 14 and the server 12 operate in the same way if some of the client systems 10 use the method described above in reference to FIG. 3, while other client systems 10 use the method of FIG. 6. Then, in step 132, the secure transfer key pair transmitted by the server 12 is received and stored, with the private key of the secure transfer key pair preferably remaining encrypted with the platform public key. Next, in step 134, this initialization routine is ended.

A client system 10 initialized using the subroutine 124 and not employing an embedded security system 18 operates as previously described in reference to FIG. 4 upon receiving a request to generate encrypted data for a computer readable medium 16. Since only the public key is required for use secure transfer key pair is needed for encryption, this key is similarly accessible in the storage 25 of the system, whether or not an embedded security system 18 is used. On the other hand, when a client system 10 initialized using the subroutine 124 and not employing an embedded security system 18 receives a request to decrypt previously encrypted data from a computer readable medium, the system 10 operates with the alternative program 138 shown in the flow chart of FIG. 7.

After the program is started in step 140, the system waits for a user input in step 142, indicating that such data is to be read and decrypted. Then, in step 144, the data, for example in the form of a token user key pair having a private key and pin encrypted with the public key of the secure transfer key pair, is read. Next, in step 146, the private key of the secure transfer key pair, encrypted with the public key of the platform key pair, is read from storage 25 of the client system 10. Next, in step 148, the private key of the secure transfer key pair is decrypted using the private key of the platform key pair. Next, in step 150, the encrypted material is decrypted using the private key of the secure transfer key pair. From this point, the system proceeds through a subroutine to verify the identity of the user in a number of steps which have been previously described in reference to FIG. 5 and which are therefore accorded like reference numbers.

While the preceding discussion relative to FIGS. 6 and 7 assumes that the secure transfer key pair is stored in step 132 in the form in which it is received from the server 12, with the private key of the secure transfer key pair encrypted with the public key of the platform key pair, it is understood that, alternatively, the private key of the secure transfer key pair may be decrypted at this point and stored as unencrypted. If this were done, the secure transfer private key could be read directly from storage in step 146 of FIG. 7, and used in step 150 without a need for the decryption of step 148.

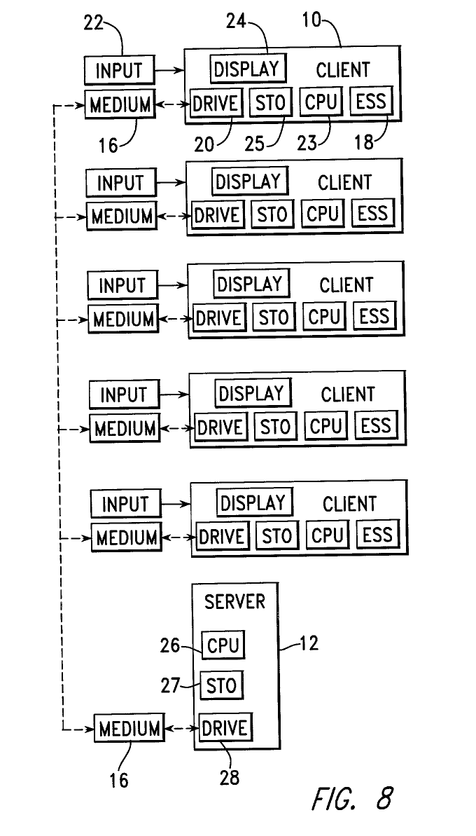

While the preceding discussion has described the client systems 10 as being connected to a server 12 by a communications network, as shown particularly in FIG. 1, a second alternate version of the present invention is carried out without requiring such connections. This second alternate version will now be described, with particular reference being made to FIG. 8, which is a block diagram of a number of associated client systems 10 in communication with a server providing cryptographic services in accordance with the second version of the present invention.

As shown in FIG. 8, the various associated client systems 10 are not connected to the server 12 by means of a communications network. Instead, the computer readable medium 16 is used to transfer the secure transfer key from the server 12 to each of the associated client systems 10. The same sort of computer readable medium 16 read and written in the drive 28 of the server 12 and in the drive 20 of each client system 10. Generally, the computer readable medium 16 is, for example, a 3.5-inch floppy diskette. This discussion is not meant to imply that the same particular medium 16 has to be used for all of the operations shown.

As previously described in reference to FIGS. 3 and 6, the previously-described versions of the present invention include a step 46 in which a platform public key is transmitted to from the client system 10 to the server 12 over a communications network 14 and a step 52 in which the secure transfer key pair is transferred from the server 12 to the client system 10, with the private key of the secure transfer key pair, encrypted with the platform public key, is transmitted from the server 12 to the client system 10.

As shown in FIG. 9, according to the second alternative version of the present invention, these steps are replaced by corresponding steps in a data transfer process 154 used to transfer data on a computer readable medium. Thus, step 46 is replaced by step 156, in which data is written to a computer readable medium 16 at the client system 10. This data includes the platform public key of the client system 10. This medium is then transported, for example, by physically carrying or by mailing, in step 158 to the server 12. Then, at the server 12, the data recorded on the medium 12 is read in step 160. After step 50 occurs within the server 12 (as shown in FIG. 3), the secure transfer key pair, having a private key encrypted with the platform public key of the client system 10 to which the transfer public key is being sent, is written in step 162 to a computer readable medium. This medium is transported to the client system in step 164, to be read by the client system 10 in step 166.

While the present invention has been described in its preferred forms or embodiments with some degree of particularity, it is understood that this description have been given only by way of example and that numerous change may be made without departing from the spirit and scope of the invention.

what is claimed is:

1. A system for encrypting a portion of token data, for recording said token data with a portion of said token data in an encrypted form on a computer readable medium, and for reading said token data and decrypting said portion of said token data, wherein
said system comprises a plurality of client computers and a server,
said server generates a secure transfer key pair and encrypts a private key of said secure transfer key pair,
said secure transfer key pair is transferred to each of said client computers in said plurality thereof with said private key of said secure transfer key pair in an encrypted form,
each client computer in said plurality thereof is programmed to generate token data including said portion of said token data encrypted with a public key of said secure transfer key pair, to record said token data on a computer readable medium, to read said token data from said computer readable medium, to decrypt said private key of said secure transfer key pair, and to decrypt said portion of said token data with said private key of said secure transfer key pair.

2. The system of claim 1, wherein
each client computer in said plurality thereof generates a platform key pair,
a public key of said platform key pair is transferred to said server,
said secure transfer key pair is transferred to each of said client computers in said plurality thereof with said private key of said secure transfer key pair encrypted with said public key of said platform key pair of said client computer, and each client computer in said plurality thereof stores said secure transfer key pair with said private key of said secure transfer key pair encrypted with said public key of said platform key pair and subsequently decrypts said private key of said secure transfer key pair with said private key of said platform key pair.

3. The system of claim 2, wherein
each client computer in said plurality thereof includes a security subsystem having a subsystem processor and subsystem storage,
each client computer in said plurality thereof generates a hardware key pair within said security subsystem
a private key of said hardware key pair is stored in said subsystem storage, and
a private key of said platform key pair is encrypted with said hardware public key and is decrypted with said hardware private key in said security subsystem before said private key of said platform key pair is used to decrypt said private key of said secure transfer key pair within said security subsystem.

4. The system of claim 1, wherein each client computer within said plurality of client computers is enabled to perform a predetermined task in response to decrypting said portion of said token data.

5. The system of claim 1, wherein
each client computer in said plurality of client computers includes an input device for providing a numeric input,
said portion of said token data includes a PIN,
each client computer in said plurality of client computers, after decrypting said portion of said token data read from said computer readable medium, compares said PIN included within said token data with said numeric input provided through said input device, and
each client computer within said plurality of client computers is enabled to perform a predetermined task in response to determining an equivalence between said PIN and said numeric input provided through said input device.

6. The system of claim 1, wherein
said system additionally comprises a communications network connecting said server with each of said client computers in said plurality thereof, and
said secure transfer key is transmitted over said communications network from said server to each of said client computers in said plurality thereof with said private key of said secure transfer key pair in said encrypted form.

7. The system of claim 6, wherein
each client computer in said plurality thereof generates a platform key pair and transmits a public key of said platform key pair to said server over said communications network,
said server transmits said secure transfer key pair over said communications network to each of said client computers in said plurality thereof with said platform key pair of said client computer, and
each client computer in said plurality thereof stores said secure transfer key pair with said private key of said secure transfer key pair encrypted with said public key of said platform key pair and subsequently decrypts said private key of said secure transfer key pair with said private key of said platform key pair.

8. The system of claim 1, wherein
said server writes said secure transfer key pair on a computer readable medium with said private key of said secure transfer key pair in said encrypted form, and
each of said client computers in said plurality thereof reads said secure transfer key pair with said private key of said secure transfer key pair in said encrypted form from said computer readable medium.

9. The system of claim 8, wherein
each client computer in said plurality thereof generates a platform key pair and writes a public key of said platform key pair on a first computer readable medium,
said server reads said public key of said platform key pair from each client computer in said plurality thereof, encrypts said private key of said secure transfer key pair with said public key of said platform key pair, and writes said secure transfer key pair on a second computer readable medium with said private key of said secure transfer key pair encrypted with said public key of said client computer,
said client computer reads said secure transfer key pair with said private key so said secure transfer key pair encrypted with said public key of said client computer from said second computer readable medium, stores said secure transfer key pair with said private key of said secure transfer key pair encrypted with said public key of said platform key pair and subsequently decrypts said private key of said secure transfer key pair with said private key of said platform key pair.

10. A method within a computing system for encrypting token data, for recording said token data in an encrypted form on a computer readable medium, and for reading and decrypting token data recorded on a computer readable medium, wherein said method comprises:
receiving a secure transfer key pair;
storing said secure transfer key pair;
after storing said secure transfer key pair, in response to an indication that token data is to be recorded, encrypting a portion of said token data with a public key of said secure transfer key pair; and recording said token data, including said portion of said token data encrypted with said public key of said secure transfer key pair on a computer readable medium; and
after storing said secure transfer key pair, in response to an indication that token data is to be read, reading said token data from a computer readable medium, and decrypting a portion of said data with a private key of said secure transfer key pair.

11. The method of claim 10, wherein said secure transfer key pair is received from said server over a communications network.

12. The method of claim 11, additionally comprising:
generating and storing a platform key pair;
transmitting a public key of said platform key pair to said server over said communications network, wherein said secure transfer key pair is subsequently received from said server encrypted with said public key of said platform key pair, and wherein said private key of said secure transfer key pair is stored encrypted with said public key of said platform key pair, and
decrypting said private key of said secure transfer key pair with said private key of said platform key pair before decrypting said portion of said data with said private key of said secure transfer key pair.

13. The method of claim 10, wherein said secure transfer key pair is read from a computer readable medium.

14. The method of claim 13, additionally comprising: generating and storing a platform key pair; writing a public key of said platform key pair on a computer readable medium,
reading said secure transfer key pair from a computer readable medium encrypted with said public key of said platform key pair, and wherein said private key of said secure transfer key pair is stored encrypted with said public key of said platform key pair, and
decrypting said private key of said secure transfer key pair with said private key of said platform key pair before decrypting said portion of said data with said private key of said secure transfer key pair.

15. The method of claim 10, additionally comprising:
generating and storing a hardware key pair within a security subsystem of said computing system, wherein a private key of said hardware key pair is stored within said security subsystem of said computing system;
encrypting said private key of said platform key pair with said public key of said hardware key pair, wherein said platform key pair is stored with said private key of said platform key pair encrypted with said public key of said hardware key pair; and
decrypting said private key of said platform key pair with said private key of said hardware key pair within said security subsystem before decrypting said private key of said secure transfer key pair with said private key of said platform key pair.

16. The method of claim 10, additionally comprising enabling performance of a predetermined task in response to decrypting said portion of said data with said private key of said secure transfer key pair.

17. The method of claim 10, wherein
said portion of said token data includes a PIN, and
said method additionally comprises receiving a numeric input from an input device, comparing said PIN with said numeric input from said input device, and enabling performance of a predetermined task in response to determining an equivalence between said PIN and said numeric input.

18. A computer readable medium having recorded thereon computer executable instructions for performing a method within a computing system for encrypting token data, for recording said token data in an encrypted form on a computer readable medium, and for reading and decrypting token data recorded on a computer readable medium, wherein said method comprises:
receiving a secure transfer key pair from said server;storing said secure transfer key pair;
after storing said secure transfer key pair, in response to an indication that token data is to be recorded, encrypting a portion of said token data with a public key of said secure transfer key pair; and recording said token data, including said portion of said token data encrypted with said public key of said secure transfer key pair on a computer readable medium; and
after storing said secure transfer key pair, in response to an indication that token data is to be read, reading said token data from a computer readable medium, and decrypting a portion of said data with a private key of said secure transfer key pair.

19. The computer readable medium of claim 18, wherein said secure transfer key pair is received from said server over a communications network.

20. The computer readable medium of claim 19, wherein said method additionally comprises:
generating and storing a platform key pair;
transmitting a public key of said platform key pair to said server over said communications network, wherein said secure transfer key pair is subsequently received from said server encrypted with said public key of said platform key pair, and wherein said private key of said secure transfer key pair is stored encrypted with said public key of said platform key pair, and
decrypting said private key of said secure transfer key pair with said private key of said platform key pair before decrypting said portion of said data with said private key of said secure transfer key pair.

21. The computer readable medium of claim 18, wherein said secure transfer key pair is read from a computer readable medium.

22. The computer readable medium of claim 21, wherein said method additionally comprises:
generating and storing a platform key pair;
writing a public key of said platform key pair on a computer readable medium,
reading said secure transfer key pair from a computer readable medium encrypted with said public key of said platform key pair, and wherein said private key of said secure transfer key pair is stored encrypted with said public key of said platform key pair, and
decrypting said private key of said secure transfer key pair with said private key of said platform key pair before decrypting said portion of said data with said private key of said secure transfer key pair.

23. The computer readable medium of claim 18, wherein said method additionally comprises:
generating and storing a hardware key pair within a security subsystem of said computing system, wherein a private key of said hardware key pair is stored within said security subsystem of said computing system;encrypting said private key of said platform key pair with said public key of said hardware key pair, wherein said platform key pair is stored with said private key of said platform key pair encrypted with said public key of said hardware key pair; and
decrypting said private key of said platform key pair with said private key of said hardware key pair within said security subsystem before decrypting said private key of said secure transfer key pair with said private key of said platform key pair.

24. The computer readable medium of claim 18, wherein said method additionally comprises enabling performance of a predetermined task in response to decrypting said portion of said data with said private key of said secure transfer key pair.

25. The computer readable medium of claim 18, wherein:
said portion of said token data includes a PIN, and
said method additionally comprises receiving a numeric input from an input device, comparing said PIN with said numeric input from said input device, and enabling performance of a predetermined task in response to determining an equivalence between said PIN and said numeric input.

26. A process of providing electrical signals over a communications network causing computer storage to have stored therein computer executable instructions for performing a method within a computing system for encrypting token data, for recording said token data in an encrypted form on a computer readable medium, and for reading and decrypting token data recorded on a computer readable medium, wherein said method comprises:
receiving a secure transfer key pair from said server;
storing said secure transfer key pair;after storing said secure transfer key pair, in response to an indication that token data is to be recorded, encrypting a portion of said token data with a public key of said secure transfer key pair; and recording said token data, including said portion of said token data encrypted with said public key of said secure transfer key pair on a computer readable medium; and
after storing said secure transfer key pair, in response to an indication that token data is to be read, reading said token data from a computer readable medium, and decrypting a portion of said data with a private key of said secure transfer key pair.

27. The process of claim 26, wherein said secure transfer key pair is received from said server over a communications network.

28. The process of claim 27, wherein said method additionally comprises:
generating and storing a platform key pair;
transmitting a public key of said platform key pair to said server over said communications network, wherein said secure transfer key pair is subsequently received from said server encrypted with said public key of said platform key pair, and wherein said private key of said secure transfer key pair is stored encrypted with said public key of said platform key pair, and
decrypting said private key of said secure transfer key pair with said private key of said platform key pair before decrypting said portion of said data with said private key of said secure transfer key pair.

29. The process of claim 26, wherein said secure transfer key pair is read from a computer readable medium.

30. The process of claim 29, additionally comprising: generating and storing a platform key pair;
writing a public key of said platform key pair on a computer readable medium,
reading said secure transfer key pair from a computer readable medium encrypted with said public key of said platform key pair, and wherein said private key of said secure transfer key pair is stored encrypted with said public key of said platform key pair, and
decrypting said private key of said secure transfer key pair with said private key of said platform key pair before decrypting said portion of said data with said private key of said secure transfer key pair.

31. The process of claim 26, wherein said method additionally comprises:
generating and storing a hardware key pair within a security subsystem of said computing system, wherein a private key of said hardware key pair is stored within said security subsystem of said computing system;
encrypting said private key of said platform key pair with said public key of said hardware key pair, wherein said platform key pair is stored with said private key of said platform key pair encrypted with said public key of said hardware key pair; and
decrypting said private key of said platform key pair with said private key of said hardware key pair within said security subsystem before decrypting said private key of said secure transfer key pair with said private key of said platform key pair.

32. The process of claim 26, wherein said method additionally comprises enabling performance of a predetermined task in response to decrypting said portion of said data with said private key of said secure transfer key pair.

33. The process of claim 26, wherein:
said portion of said token data includes a PIN, and
said method additionally comprises receiving a numeric input from an input device, comparing said PIN with said numeric input from said input device, and enabling performance of a predetermined task in response to determining an equivalence between said PIN and said numeric input.

34. A method for enabling performance of a predetermined task in a remote computer system through use of an encrypted portion of token data recorded in a local computer, wherein said method comprises:
transferring a secure transfer key pair from said server to said local computer;
storing said secure transfer key pair within said local computer;
establishing communication between said remote computer and said server;
transferring said secure transfer key pair from said server to said remote computer;
storing said secure transfer key pair within said remote computer;
encrypting said portion of said token data within said local computer with a public key of said secure transfer key pair;
recording said token data, including said portion of said token data encrypted with said public key of said secure transfer key pair, within said local computer on a computer readable medium;
transporting said computer readable medium from said local computer to said remote computer;reading said token data, including said portion of said token data encrypted with said public key of said secure transfer key pair, within said remote computer from a computer readable medium;
decrypting said portion of said token data within said remote computer with a private key of said secure transfer key pair; and
enabling said performance of said predetermined task in said remote computer in response to said portion of said token data.

35. The method of claim 18, wherein said secure transfer key pair is received from said server over a communications network.

36. The method of claim 34, additionally comprising:
generating and storing a first platform key pair within said local computer; and
transmitting a public key of said first platform key pair to said server from said local computer, wherein said secure transfer key pair is subsequently received by said local computer from said server encrypted with said public key of said first platform key pair, and wherein said private key of said secure transfer key pair is stored within said local computer encrypted with said public key of said first platform key pair.

37. The method of claim 34, wherein said secure transfer key pair is read from a computer readable medium.

38. The method of claim 37, wherein said method additionally comprises:
generating and storing a platform key pair;
writing a public key of said platform key pair on a computer readable medium,
reading said secure transfer key pair from a computer readable medium encrypted with said public key of said platform key pair, and wherein said private key of said secure transfer key pair is stored encrypted with said public key of said platform key pair, and
decrypting said private key of said secure transfer key pair with said private key of said platform key pair before decrypting said portion of said data with said private key of said secure transfer key pair.

39. The method of claim 34, additionally comprising:
generating and storing a first hardware key pair in a security subsystem of said local computer, wherein a private key of said hardware key pair is stored within said security subsystem of said local computer;
encrypting said private key of said first platform key pair with said public key of said first hardware key pair within said local computer, wherein said first platform key pair is stored within said local computer with said private key of said first platform key pair encrypted with said public key of said first hardware key pair.

40. The method of claim 34, additionally comprising:
generating and storing a second platform key pair within said remote computer;
transmitting a public key of said second platform key pair to said server from said remote computer, wherein said secure transfer key pair is subsequently received by said remote computer from said server encrypted with said public key of said second platform key pair, and wherein said private key of said secure transfer key pair is stored within said remote computer encrypted with said public key of said second platform key pair, and
decrypting said private key of said secure transfer key pair with said private key of said second platform key pair within said remote computer before decrypting said portion of said data with said private key of said secure transfer key pair.

41. The method of claim 34, additionally comprising:
generating and storing a second hardware key pair within a security subsystem of said remove computer, wherein a private key of said hardware key pair is stored within said security subsystem of said remote computer;
encrypting said private key of said second platform key pair with said public key of said second hardware key pair within said remote computer, wherein said second platform key pair is stored within said remote computer with said private key of said second platform key pair encrypted with said public key of said second hardware key pair; and
decrypting said private key of said second platform key pair with said private key of said second hardware key pair within said security subsystem of said remote computer before decrypting said private key of said secure transfer key pair with said private key of said second platform key pair.

42. The method of claim 36, additionally comprising enabling performance of a predetermined task within said remote computer in response to decrypting said portion of said data with said private key of said secure transfer key pair.

43. The method of claim 36, wherein
said portion of said token data encrypted with said public key of said secure transfer key pair includes a PIN, and
said method additionally comprises receiving a numeric input within said remote computer from an input device, comparing said PIN with said numeric input from said input device, and enabling performance of a predetermined task within said remote computer in response to determining an equivalence between said PIN and said numeric input.

44. A method for establishing a plurality of associated client computers, wherein a client computer in said plurality of associated client computers performs a predetermined task in response to reading and decrypting token data recorded on a computer readable medium, wherein said method comprises:
generating a secure transfer key pair within a server;
transferring said secure transfer key pair from said server to each client computer in said plurality of associated client computers;
storing said secure transfer key pair within each client computer in said plurality of associated client computers;
encrypting a first portion of token data with a public key of said secure transfer key pair within a first client computer within said plurality of associated client computers;
recording token data on a computer readable medium, wherein said token data includes said first portion of token data encrypted with said public key of said secure transfer key pair, in said first client computer;
transferring said computer readable medium from said first client computer to a second client computer within said plurality of associated client computers;
reading said token data on said second client computer; and
decrypting said token data encrypted with said public key of said secure transfer key pair with a private key of said secure transfer key pair in said second client computer.

45. The method of claim 44, wherein
each client computer within said plurality of associated client computers generates a platform key pair,
a public key of said platform key pair is transferred from said client computer to said server,
said private key of said secure transfer key pair is encrypted within said server with said public key of said platform key pair,
said secure transfer key pair is transferred from said server to said client computer with a private key of said secure transfer key pair encrypted with said public key of said platform key pair.

46. The method of claim 45, wherein said secure transfer key pair is transferred from said server to said client computer on a computer readable medium.

47. The method of claim 45, wherein said secure transfer key pair is transferred from said server to said client computer by transmission over a communications network.

48. The method of claim 45, additionally comprising:
generating and storing a hardware key pair within a security subsystem of said client system, wherein a private key of said hardware key pair is stored within said security subsystem of said client computer;
encrypting said private key of said platform key pair with said public key of said hardware key pair, wherein said platform key pair is stored with said private key of said platform key pair encrypted with said public key of said hardware key pair; and
decrypting said private key of said platform key pair with said private key of said hardware key pair within said security subsystem before decrypting said private key of said secure transfer key pair with said private key of said platform key pair.

49. The method of claim 10, wherein
a portion of said token data includes a PIN, and said method additionally comprises receiving a numeric input from an input device, comparing said PIN with said numeric input from said input device, and enabling performance of a predetermined task in response to determining an equivalence between said PIN and said numeric input.

50. A method for establishing a plurality of associated client computers, wherein a client computer in said plurality of associated client computers performs a predetermined task in response to reading and decrypting token data recorded on a computer readable medium, wherein said method comprises:
generating a secure transfer key pair within a server;
transferring said secure transfer key pair from said server to each client computer in said plurality of associated client computers; and
storing said secure transfer key pair within each client computer in said plurality of associated client computers.

51. The method of claim 50, wherein
said method additionally comprises receiving a platform key pair from said client computer within said plurality of associated client computers before transferring said secure transfer key pair to said client computer,
said secure transfer key pair is transferred from said server to said client computer with a private key of said secure transfer key pair encrypted with said public key of said platform key pair.

52. The method of claim 51, wherein said secure transfer key pair is transferred from said server to said client computer over a communications network.

53. The method of claim 51, wherein said secure transfer key pair is transferred from said server to said client computer as data recorded on a computer readable medium.
